(19) United States
(12) Patent Application Publication
(10) Pub. No.: US 2021/0124328 A1
(43) Pub. Date: Apr. 29, 2021

(54) SYSTEMS AND METHODS FOR OPTIMIZING TESTING, PREPARATION AND EXECUTION

(71) Applicant: Real Eats America Inc., Geneva, NY (US)

(72) Inventor: Daniel Wise, Westmount (CA)

(21) Appl. No.: 17/140,485

(22) Filed: Jan. 4, 2021

Related U.S. Application Data
(63) Continuation-in-part of application No. 16/206,456, filed on Nov. 30, 2018.
(60) Provisional application No. 62/593,112, filed on Nov. 30, 2017.

(51) Int. Cl. G05B 19/042; G05B 19/418

(52) U.S. Cl. CPC G05B 19/0428; G05B 19/41865; G05B 19/4183

(57) ABSTRACT

Provided is a system that manages and executes creation of recipes prepared and delivered in a vacuum-packed format, created by cooking the ingredients to sensor defined levels, blast chilling and confirming chilled temperature, then vacuum packing to lock in the flavor, freshness and nutrition of real and never processed food. The packaging can also include sensors to ensure the quality and viability of the delivered product. In one example, a vacuum sensor is integrated into the packaging to provide a visual indicator that the vacuum seal is intact from preparation to delivery. Additionally temperature sensors can also be included to provide another indicator that temperate has remained a specified level from preparation to delivery. Once delivered, the food lasts for at least seven days in the fridge, and final steps are limited to heated in boiling water (e.g., in six minutes), without any preparation or cleanup.

### RELATED APPLICATIONS

This application is a continuation-in-part of U.S. patent application Ser. No. 16/206,456 filed on Nov. 30, 2018, which is a non-provisional of and claims under § 119(e) the benefit of U.S. Provisional Application No. 62/593,112, titled “SYSTEMS AND METHODS FOR OPTIMIZING TESTING, PREPARATION AND EXECUTION,” filed on Nov. 30, 2017, which application is incorporated by reference in its entirety.

### BACKGROUND

Various preparation services exists that attempt to deliver meals to customers. For example, some services attempt to deliver ingredients and instruction or kits that can be refrigerated and later prepared. Typically, these services offer a cooking experience that can be delivered in a form that provides all ingredients and instructions to be follow in preparing the delivered items into a meal.

### SUMMARY

The inventors have realized that there is a need for a system that can create a complete meal that can be delivered fresh, with minimal requirements on the end user. According to various aspects, a system and method are provided for compiling, preparing, and delivering freshly prepared meals. In some embodiments, the system manages and executes creation of recipes prepared and delivered in a vacuum-packed format, these options are created by cooking the ingredients to set levels, blast chilling, then vacuum packing to lock in the flavor, freshness and nutrition of real and never processed food. Once delivered, the food lasts for at least seven days in the fridge, and final steps are limit to heated in boiling water (e.g., in six minutes), without any prep, cleanup or even a microwave required.

According to one embodiment, the system is configured to forecast customer orders to generate a purchasing guide and to procure product sufficient to fulfill the projected demand. According to some embodiments, the system is configured to dynamically adjust the product purchase model over time. As the deadline for closing the order window approaches, the system's forecast becomes more and more accurate, for example, as the system recalculates and/or confirms the purchase model. In some examples, re-calculation can occur periodically, continuously, a-periodically, etc. According to one embodiment, the system is configured to fine tune the purchase model based on known orders and to ensure the system can accommodate the volume (including for example, human or chef based resources and time).

According to various aspects, systems and methods are provided for compiling, preparing, and delivering freshly prepared meals. According to some embodiments, the system is configured to automatically generate a prep list. The prep list is created for operational culinary staff to prepare meals, and where preparation steps can be automated. The food is prepared according to developed/tested specifications and once the minimum specifications are met the product is rapidly cooled using either a blast chiller or ice bath. Once cooled, the product is portioned to satisfy nutritional guidelines (e.g., and/or serving size), and loaded into vacuum bags. In addition, the system is configured to display at least three Chef designed meals that dynamically change on the system every week, offering over one hundred unique options each period for user selection. In one example, the Chef Selections menu is displayed as a first portion of the system user interface.

According to one aspect, a production system for managing testing, preparation and delivery of product is provided. The system comprises at least one processor operatively connected to a memory, a preprocessing controller, executed by the at least one processor, configured to manage pre-production execution (e.g., based on analyzing an expected number of needed product) (e.g., to produce a product according to a recipe)), a first set of sensors configured to monitor a first production stage (e.g., cooking stage) for the product, automation controller, executed by the at least one processor, configured to receive monitored (e.g., temperature) information from the first set of sensors, and control transition from the first production stage to at least a second stage of the production responsive to exceeding a threshold (e.g., temperature) measured by the first set of sensor systems, a second set of sensor systems configured to monitor a second production stage for the product, wherein the automation controller is configured to control a transition from the second production stage to a third production stage, a transit controller, executed by the at least one processor, configured to control generation of cooling material to include with the product for loading in a shipping container, and trigger delivery of the product to respective users.

According to one aspect, a production system for managing testing, preparation and delivery of product is provided. The system comprises at least one processor operatively connected to a memory, a preprocessing controller, executed by the at least one processor, configured to manage pre-production inventory (e.g., based on analyzing an expected number of needed product), an automation controller, executed by the at least one processor, configured to control at least a first set of sensor systems for monitoring production, and control transition from a first preparation stage of the production to at least a second stage of the production responsive to exceeding a threshold measured by the first set of sensor systems (e.g., temperature threshold), and a transit controller, executed by the at least one processor, configured to manage packaging and delivery of product to respective users.

According to one embodiment, the system further comprises a set of ovens for cooking product, wherein the at least the first set of sensor system are configured to monitor a temperature of the product during cooking. According to one embodiment, the system further comprises a cooling unit configured to rapidly cool the product. According to one embodiment, the automation controller is configured manage the transition from the ovens to the cooling unit. According to one embodiment the at the first set of sensors systems includes temperature detectors disposed in a cooling unit, where in the automation controller is configured to control a transition from a cooling stage for the product to a packing stage for the product. According to one embodiment, the system further comprising a packing controller configured to vacuum seal the product, responsive to determining the product has reached a threshold temperature. According to one embodiment the transit controller is configured to generate cooling material for packing with the product. According to one embodiment the transit controller is configured to determine a needed volume of cooling material based on a destination for the product. According to one embodiment, the transit controller is configured to determine a needed volume of cooling material based on a temperature analysis (e.g., based on a destination for the product and/or expected weather patterns).

According to one aspect, a method for managing testing, preparation and delivery of product is provided. The method comprises accessing, by at least one processor, an expected number of subscribers, automatically adjusting, by the at least one processor pre-production inventory responsive to the expected number of subscribers and associated requests for the product; (e.g., based on analyzing an expected number of needed product which can be based at least in part of a number of subscribers), triggering a first production phase for the product, monitoring, the first production phase with a first set of sensors to determine the product meets a first threshold temperature, transitioning from the first production phase to a second production phase responsive to meeting the first threshold, monitoring the second production phase with a second set of sensors to determine the product meets a second threshold temperature, transitioning from the second production phase to a third production phase responsive to meeting the second threshold, and generating and packing cooling material with the product based on respective delivery information for respective users.

According to one embodiment, the method further comprises cooking the product in the first production phase, and the wherein first set of sensors are configured to monitor a temperature of the product during cooking. According to one embodiment, the method further comprises rapidly cooling the product in the second production phase. According to one embodiment, the act of transitioning from the first production phase to a second production phase is controlled by an automation unit for managing the transition from a set of ovens to a cooling unit. According to one embodiment, the second set of sensors includes temperature detectors disposed in a cooling unit, where in the automation controller is configured to control a transition from a cooling stage for the product to a packing stage for the product. According to one embodiment, method further comprises vacuum sealing the product, responsive to determining the product has reached a threshold temperature. According to one embodiment, the method further comprises generating cooling material for packing with the product. According to one embodiment, the method further comprises determine a needed volume of cooling material based on a destination for the product. According to one embodiment, the method further comprising monitoring the product during the third production phase to ensure a vacuum seal is maintained throughout shipping. According to one embodiment, the act of monitoring the product during the third production phase including visually inspecting an integrated sensor on a vacuum sealed bag using a camera.

According to one aspect, a production system for managing testing, preparation and delivery is provided. The system comprises at least one processor operatively connected to a memory, the at least one processor when executing configured to estimate a current demand for respective orders displayed to end users, generate a product model associated with the estimated current demand, revise over time the product model responsive to user submitted orders, validate resource allocation and the product model responsive to any revision, wherein testing determines compliance with scheduled resources and delivery constraints, alert administrator responsive to testing determining failed compliance with scheduled resources and delivery constraints, and allocate additional resources to resolve failed conditions.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of an example system for managing preparation and execution, according to one embodiment;

FIG. 2 a block diagram of an example system for managing preparation and execution, according to one embodiment;

FIG. 3 is an example process flow for preparation and execution, according to one embodiment;

FIG. 4 is a block diagram of is a special purpose computer system program to execute the processes and/or functions described herein improving over conventional computer systems;

FIG. 5 is a logic flow for a web site, according to one embodiment;

FIGS. 6-9 are example screen captures of user interfaces, according to some embodiments;

FIG. 10 is a logical description of information obtained or used by various interfaces, according to one embodiment; and

FIGS. 11-13 are example screen captures of user interfaces, according to some embodiments.

### DETAILED DESCRIPTION

According to various aspects, systems and methods are provided for compiling, preparing, and delivering freshly prepared meals. In some embodiments, the system manages and executes creation of recipes prepared and delivered in a vacuum-packed format, these options are created by cooking the ingredients to sensor defined levels, blast chilling and confirming chilled temperature, then vacuum packing to lock in the flavor, freshness and nutrition of real and never processed food. The vacuum packaging can also include sensors to ensure the quality and viability of the delivered product. In one example, a vacuum sensor is integrated into the packaging to provide a visual indicator that the vacuum seal is intact from preparation to delivery. Additionally temperature sensors can also be included to provide another indicator that temperate has remained a specified level from preparation to delivery. Once delivered, the food lasts for at least seven days in the fridge, and final steps are limited to heated in boiling water (e.g., in six minutes), without any prep, cleanup or even a microwave required.

According to some embodiments, the system is configured to automatically generate a prep list. According to one embodiment, the prep list is created dynamically by the system based on current subscription levels, and the prep list can be used by operational culinary staff to prepare meals. In one example, the system generated product purchase model is used to order any ingredients not on hand or subject to spoilage. The system is configured to coordinate the ordering such that the ingredients are received and then processed in the production kitchen according to a resource model. The resource model allocates ingredients, personnel, and validates that sufficient ingredients and resources are assigned to meet demand and the delivery schedule. Product can be prepared according to developed/tested specifications (e.g., prior test runs can be used to validate menu options, recipes, and establish resource assignment benchmarks). For example, the specifications can include minimal cooking temperatures as outlined by the Department of Agriculture and Markets that must be achieved. In one example, sensor systems are configured to monitor the production process to confirm or validate minimum specifications for food preparation are met.

According to one embodiment, once the minimum specifications are met (e.g., sensor data validates the minimum temperature has been achieved), the product is rapidly cooled using either a blast chiller or ice bath. Once cooled, the product is portioned to satisfy nutritional guidelines (e.g., and/or serving size), and loaded into 3-mm vacuum bags. The bags can be automatically or manually loaded into a large format vacuum machine and sealed. According to various embodiments, the system generates and reviews resource allocation information to ensure that sufficient human based resources are allocated for the production process, and may monitoring on-going production processing to refine and update the resource allocation model. Sealed food is labeled with an identifying sticker (meal, content, use by date) and loaded onto carts for order picking kept in a suitable environment (e.g., refrigerated coolers). On ship day, orders are manually picked and packed into insulated shipping boxes with frozen gel packs to maintain a food-safe temperature during transit. Some orders are picked up by the delivery company (FedEx) for overnight or 2-day delivery. In one example, the system includes a shipping API component that integrates with standard shipping systems. The system can invoke the shipping API to manage delivery of orders that can be picked up locally and shipped.

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

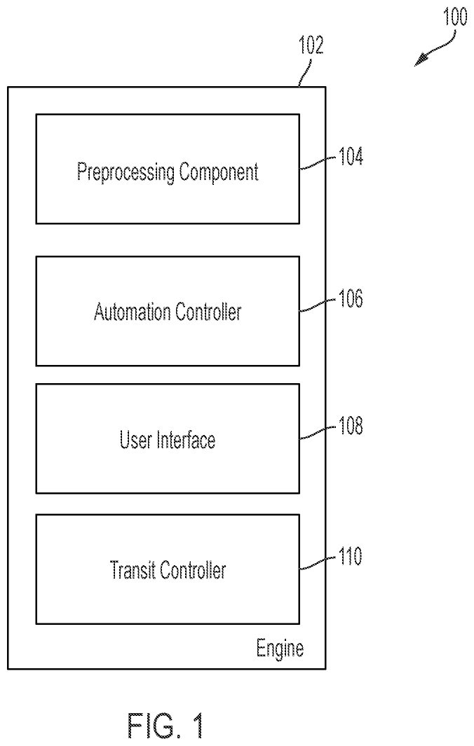

FIG. 1 is a block diagram of a processing and execution system 100. According to various embodiments, system 100 can instantiate a processing engine 102 configured to manage ingredients needed based on determining a number of subscribers, respective orders, and/or on hand inventory, among other options. The system 100 and/or engine 102 can be configured to compile, prepare, and deliver freshly prepared meals to end users, while ensuring minimum temperate requirement are met across the board (e.g., minimum cook temperatures, maximum transit temperatures, as well as provide visual indications of failed packaging, among other options).

In some embodiments, the system manages and executes creation of product that is prepared and delivered in a vacuum-packed format, where these product options are created by cooking the ingredients to sensor monitored levels, blast chilling (e.g., monitored by sensors) and confirming chilled temperature, then vacuum packing the product to lock in the flavor, freshness and nutrition of real and never processed food. The vacuum packaging can also include sensors to ensure the quality and viability of the delivered product. In one example, a vacuum sensor is integrated into the packaging to provide a visual indicator that the vacuum seal is intact from preparation to delivery. Additionally temperature sensors can also be included to provide another indicator that temperature has remained at a specified level from preparation to delivery. Once delivered, the food lasts for at least seven days in the fridge, and final steps are limited to heating in boiling water (e.g., in six minutes), without any prep, cleanup or even a microwave required. In some examples, the system can automatically respond to above threshold sensors signals, and ship new product responsive to a failed sensor reading, for example.

According to various embodiments, the system can be configured to instantiate specialized components/controllers (e.g., engine 102) to execute the functions discussed herein. In other embodiments, the system can execute those functionality without instantiate the described components or engines. In one embodiments, the system includes pre-processing component or controller 104. According to various embodiments, the pre-processing component can be configured to manage ingredient ordering lists, manage on hand inventory, and dynamically order new ingredients responsive to spoilage and/or use modelling. According to one example, the pre-processing component 104 can be configured to dynamically adjust order for fresh ingredients based on analyzing current subscribers, and/or individual orders, and to accommodate ingredient spoilage.

According to some embodiments, the pre-processing component 104 can also be configured to manage system sensor settings. For example, culinary staff and/or system administrators can establish minimum cook temperatures for various products/recipes using the pre-processing component. In further example, each recipe can be associated with a custom temperature setting that meets regulatory requirements. As discussed in greater detail below, an automation controller (e.g., 106) can be configured to continuously, periodically, or a-periodically monitor food product as it is being prepared and/or cooked, and trigger automation to move the food product to an ice bath responsive to reaching the pre-processing component's specified temperature.

According to various embodiments, system 100 and/or engine 102 can include an automation controller 106. The automation controller can be configured to automatically transition prepared product from one execution stage to another. For example, the automation controller 106 can transition food from a cook stage to a cool stage responsive to monitored temperature of the food being prepared. In one example, the system can include non-contact thermometers configured to monitor the temperature of food as it is being cooked. In other examples, contact sensors can also be automated and used to control transitions between preparation stages.

In some embodiments, the pre-processing component 104 and automation controller 106 can perform co-operative refinements to the preparation functions of the system. According to one example, user can provide feedback regarding prior orders (e.g., undercooked, over-cooked, prefer well done, etc.). The user feedback can be used by the system to dynamically adjust temperature settings (e.g., increase one degree, two degree, etc. responsive to a well done request or undercooked feedback, or decrease one degree, two degree etc., responsive to a rare request or overcooked feedback—while maintaining regulatory minimum temperatures.). In other embodiments, the system can also use cook time (alone or in conjunction with sensor readings) to control the automation transitions between stages. In further example, the system, engine, and/or pre-processing component can be configured to group product based on temperate (e.g., custom temperatures) desired and associate custom settings with specific users for later delivery.

As discussed above, system 100 and/or engine 102 can include an automation controller 106. The automation controller can be configured to transition food product between preparation stages (e.g., cook, cool, packing, and/or delivery). The automation controller 106 can be configured to execution transitions between stage based on elapsed time, temperature readings, and/or combinations of time and temperature. In one example, minimums for both options are tested and validate before a transition is executed.

According one embodiment, the automation controller 106 is configured to require a minimum temperature, and the automation controller 106 can be configured to monitor cooked temperatures achieved. In some settings, the automation controller 106 can be configured to sample from the food being prepared to determine that a respective batch meets a minimum temperature requirement. In further examples, sensor reading can be analyzed by the system to identify and adjust for hot spots in ovens (e.g., sample temperature more frequently around hot spots, position food product away from hot spots, etc.).

Similarly, once a transition to the cooling stage is executed, respective sensors in the cooling stage can be used by the automation controller 106 to validate a cooling temperature is reached. In one embodiment, the system is configured transition cooked food to an ice bath to reach a desired transit temperature. In other embodiments, a blast chiller can be triggered by the automation controller. Once the transit temperature is reached, the product can be portioned (e.g., cut or sized for serving), and the automation controller 106 can feed the product into a vacuum sealing device. In one example, the vacuum sealing device can be managed, controlled, and/or executed under the controller of the automation controller.

As discussed, in various embodiments, the food is prepared according to developed/tested specifications and once the minimum specifications are met the product is rapidly cooled using either a blast chiller or ice bath. Once cooled, the product is portioned to satisfy nutritional guidelines (e.g., and/or serving size), and loaded into vacuum sealed bags. In some embodiments, the vacuum sealed bags can incorporate additional sensors. For example, a vacuum sensor can react to changes in air pressure to change color. The system can include visual monitors to identify any breached bags prior to shipping. Typically, in conventional approaches such failures are only detected by end users or in catastrophic failure. The additional visual sensors (e.g., chemical color change responsive to pressure, increased humidity, etc.) improve issue detection over known approaches, and in some examples, does so at time when the system can readily produce additional product.

According to one embodiment, the system can include a transit controller 110 that manages delivery execution. The transit controller can also manage visual inspection of product and shipping, via cameras and/or packing sensor validation. If the product has been properly prepared the transit controller 110 can be configured to package the product with a volume of ice (e.g., dry ice) for transit. In some examples, the system can include a dry ice production unit or units for generation of cooling material for transit. In one example, the system can use estimated transit time for respective packages to determine how much cooling material to generate or include in an insulated package for each delivery. In some embodiments, customer feedback or sensor information (e.g., exposed to high temperature, failed temperature sensor reading, etc.) can cause the system to dynamically adjust cooling material production to increase volume based on a same estimated transit time. In such settings, the system can automatically adjust to unexpected conditions. In yet other examples, the system can augment cooling material estimates with weather forecasts, increasing or decreasing a volume of cooling material responsive to weather predictions in respective delivery locations.

In further embodiments, sensors embedded in the vacuum sealed bags can provide temperature data to the automation controller or transit controller to ensure that temperature is maintained through packing and transit to an end user. In various example, anomaly detection can trigger automated responses (e.g., re-cook and ship orders). Such feedback from sensor systems temperature, vacuum seal, humidity, etc. enables the system to more efficiently identify production errors and more efficiently resolve them when compared to conventional systems. Additionally the early detection and resolution mechanisms provide functionality not available in conventional approaches and yield improvements in this field, for example, detecting errors during a large production run allows the system to leverage the efficiencies of scale that are lost in conventional approaches that require users to detect issues, and singular productions to regenerate their product or order.

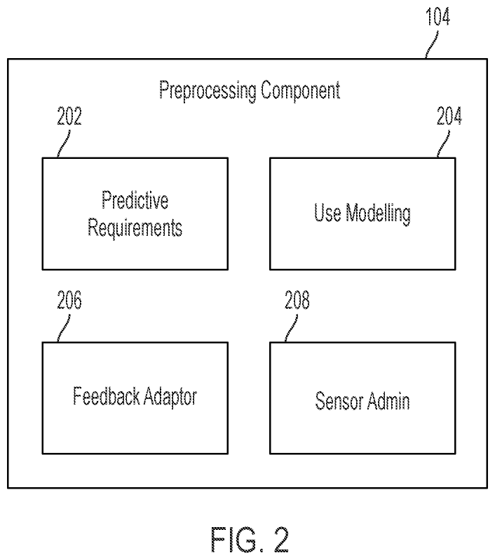

FIG. 2 is a block diagram of an example pre-processing component that can provide a number of enhanced functionality over conventional approaches. For example, the system 100, engine 102, and/or pre-processing component 104 may maintain real time information on current product inventory (e.g., ingredients), and track for the on-hand product spoilage rates. In some examples, the system is configured to monitor ingredients and usage as the ingredients get close to end of shelf life. The system 100, engine, or pre-processing can also be configured to track usage of ingredients through delivery to customers, and link reviews associated with lower qualify (e.g., bad taste, poor feedback, etc.) to end of life ingredients. Using such feedback, the system can dynamically alter usability information associated with specific ingredients.

In one embodiment, preprocessing component (PPC) 104 includes a predictive requirements component/controller (PRC) 202. The PRC 202 can be configured to model ingredient usages based on test preparation runs and extend the data obtained in the test runs to current subscriber levels. Further PRC 202 can update ingredient usage and potential spoilage information dynamically for use in order any needed ingredients dynamically, as well as part of large orders to achieve efficiencies in scale. In some examples, the PRC can include intelligent algorithms for modeling use of ingredients and/or needed ingredients for production run preparation. Test executions of recipes can be used to train a machine learning model that can then accept as input subscriber levels, requests for recipes, etc., to output an ingredient order.

In some, embodiments PPC 104 can include a use modelling component/controller (UMC) 204, configured to model all production use of ingredients, cooling materials, ovens etc., and dynamically adjust how the system/automation controller transitions between stages of preparation, or how the system/automation controller samples temperature, among other options.

In further embodiments, the system, engine, or PPC can be configured to optimize production execution based on a feedback adapter 206. In one embodiment, a feedback adapter enables clients to provide textual or verbal feedback to the system (e.g., using interface 108) which can be interpreted by the feedback adaptor 206. In some examples, feedback adapted associates comments to specific users enabling the system to alter production instructions to their needs (e.g., under done, crispier, etc.).

In various embodiments, the system and/or PPC can include a sensor administration component 208. The sensor administration component 208 can be configured to manage the various sensors in the production system (e.g., enroll, monitor data, control sample rate, etc.). In some examples, administrators or culinary operators can access the admin component 208 to set various values for minimum temperature, maximum temperature, sample rates, etc. In other embodiments, the system can apply learning algorithms to set such values or modify the set values as productions runs are completed and additional training data becomes available. As discussed above, any of the functions discussed separately with separate components can also be performed by the system or engine.

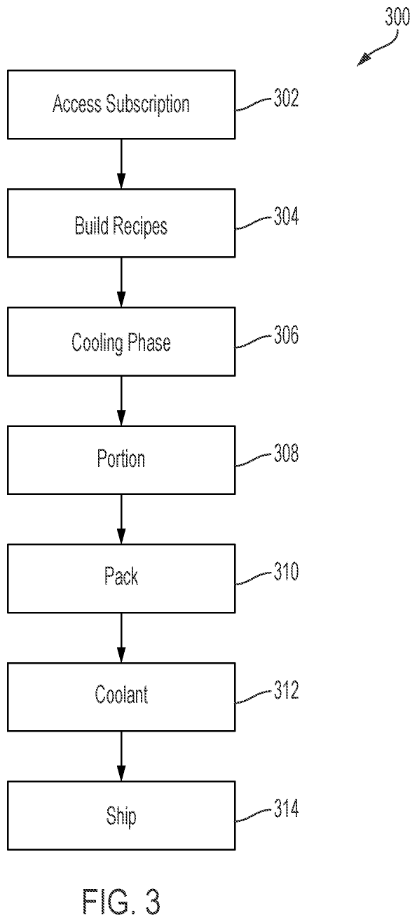

FIG. 3 is an example process 300 for preparing and delivering a recipe to a user. Process 300 beings with managing or accessing a subscription information for a group of users at 302. In some examples, each user can be associated with multiple orders for an upcoming time period. Process 300 continues with validating inventory for the orders/subscribing users to ensure that production is sufficient for demand. In some embodiments, process 300 can include ordering of ingredients automatically to ensure production will be able to meet demand. Optionally, step 302 can include forecasting to develop and expected need based on current subscription information and projections of new subscriptions to provide for increases in subscription levels up to production time. In some embodiments, a specific time window can also be used to ensure the subscription information obtained at 302 remains steady for a production execution.

At 304, the ingredients are used to create the recipes that have been requested by the subscribers. Creation at 304 can include various automated steps, and for example, temperature monitoring of the ingredients as they are cooked. Temperature monitoring can include sampling of various items during cooking to validate a minimum temperature. In some example, each item may have its own minimum temperature or have different temperatures for different recipes. In various executions, different sample rates and different minimums can be used during execution.

According to one embodiment, once minimum specifications for each recipe are met (e.g., sensor data validates the minimum temperature has been achieved), the product is rapidly cooled using either a blast chiller or ice bath at 306. In some examples, automation components are used to transition the recipe from ovens to the blast chiller or ice bath. Once cooled, the product is portioned to satisfy nutritional guidelines (e.g., and/or serving size) at 308, and loaded into 3-mm vacuum bags at 310. The bags can be automatically loaded into a large format vacuum machine and sealed. According to various embodiments, the system generates and reviews resource allocation information to ensure that sufficient human based resources are allocated for the production process, and may monitor on-going production processing to refine and update the resource allocation model (e.g., as feedback into subsequent runs of step 302).

According to one embodiment, sealed food is labeled with an identifying sticker (meal, content, use by date) and loaded onto carts for order picking, while being kept in a suitable environment (e.g., refrigerated coolers) (e.g., as part of 310). In some embodiments, information from sensors on the packaging or vacuum sealed bags can be obtained (e.g., visual sensors, etc.) and any anomalies can be resolved with additional processing.

On ship day, orders can be automatically picked and packed into insulated shipping boxes with frozen gel packs to maintain a food-safe temperature during transit at 312. In some examples, an amount of cooling material is determined based on analyzing routing information for the packages, and can include analysis of weather information, according to some examples.

In further embodiments, some orders are picked up by the delivery company (FedEx) for overnight or 2-day delivery at 316. In one example, the system includes a shipping API component that integrates with standard shipping systems. The system can invoke the shipping API to manage delivery of orders that can be picked up locally and shipped as part of 314. In further examples, other orders are packed onto a truck from a preparation facility and transited to a distribution warehouse for shipping at 316. Process 300 can be executed by a production system (e.g., 100), and can in some examples, be executed in different order or with various steps combined. In other embodiments, additional functions can be executed as part of process 300 and/or process can execute various sub-processes to perform optimizations and/or additional functions discussed herein.

In some embodiments, a production system is configured to automate the packaging process, including automation of the custom vacuum sealing processes, and inline printing/labeling of food packages as orders are created. In some examples, the system is configured to manage on site production of dry ice. The dry ice can then be used as a coolant in the shipments. In further embodiments, the system is configured to manage the allocation of coolant (e.g., gel pack and/or dry ice) to ensure a safe delivery temperature for receipt by an end user. In some examples, monitoring sensors can be included in shipping packages to provide feedback data on temperature. The temperature feedback information can be included in a resource allocation model that specifies how much of the coolant may be needed. In further examples, the system can coordinate shipments with temperature forecasts and adjust coolant needs accordingly. For example, shipping into a destination undergoing record heat wave will triggering a corresponding increase in coolant allocation.

According to further embodiments, the system is configured to accept recipes from chef personnel, for example, through a submission user interface. Once submitted, recipes are reviewed, to determine if the proposal is in line with culinary direction (e.g., nutrition evaluation, ingredient diversity, etc.) and identity and for operational viability (e.g., aligns with resource allocation models, projected demand, among other options). In some examples, senior personnel may also review the proposals as well as any system based analysis to ensure the proposal will translate well in the delivery system and processing. According to various embodiments, refinements are identified and incorporated into the recipes, which dynamically trigger the system to re-calculate projected demand and/or the product purchase model. In some settings, the system is configured to notify the submitter of proposed changes and request acceptance before modifying any recipe.

Once the recipes are finalized, the recipe can be executed during a testing phase. At that point, the recipes are formatted and are executed to physically test the recipe in production. In some examples, the system monitors performance characteristics during the testing phase and incorporates measurements of time associated with preparation, cooking, crafting, etc., into resource allocations models. As part of the testing process, the food preparation is executed through the sealing and shipping process. For example, the test run can include invoking third party shipper services. In one example, each phase is tested to ensure a complete and as accurate as possible resource mode.

Further testing can include quality control procedures. For example, samples can be sent (including, for example, shipped per normal execution) to senior staff to evaluate not only the receipt but any effect of the chilling and shipping phases of execution on taste, presentation, and/or culinary direction and identity.

Feedback can be submitted through the system, for example, through a submission user interface. Additionally, personnel can meet offline to provide critical evaluation and/or acceptance. Under the testing phase additional refinements can be made, which cause the system to dynamically adjust resource models and/or procurement models. Until the recipe and production phase is finalized, complete with yield and portion size. The information on the meal can be submitted to the system so the nutritional panels can be automatically created for each order. At times, testing indicates that the nutritional information or product that results is not in line with goals, and the process of revising begins again. Once all criteria have been met (quality, identity, nutritional, sourcing) then a recipe is photographed and ready for implementation. In some examples, the system is configured to monitor nutritional compliance during the testing phase. As changes are submitted to the system, the system can automatically alert the users/developers that a submitted change will be non-compliant. In such environments, the system managed testing executed provide significant efficiencies over conventional testing approaches. For example, the system can alert users to nutritionally non-compliant changes before testing even begins, limiting wasted resources.

### User Interface and System Display Examples:

According to one embodiment, the menu is split into at least two components: a Chef Selections display and a Best Sellers display portion. The system is configured to display at least three Chef designed meals that dynamically change on the system every week, offering over one hundred unique recipes each year for user selection. In one example, the Chef Selections menu is displayed as a first portion of the system user interface.

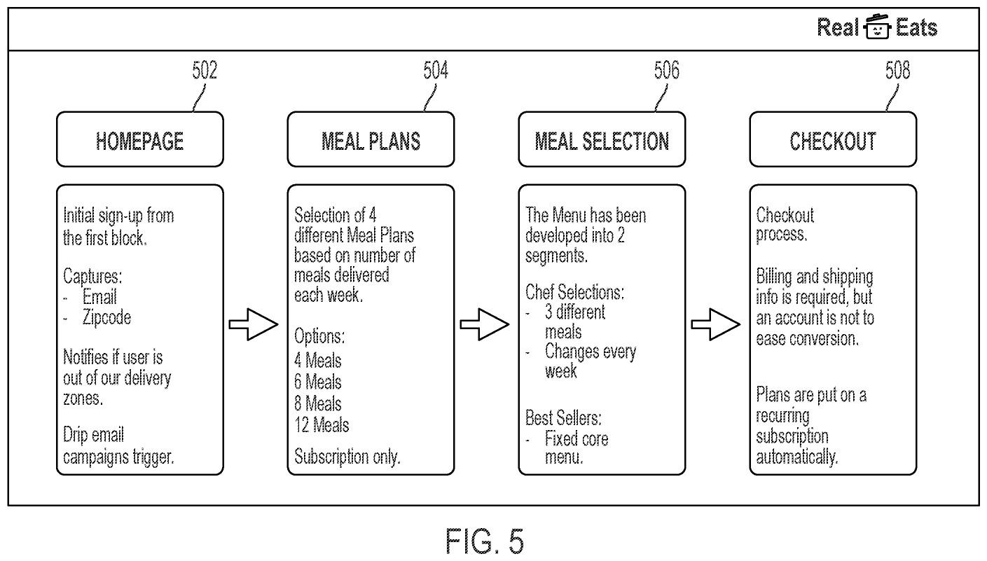

FIG. 5 illustrates a functional flow for a web site implementing various features discussed herein. Shown in FIG. 5 is a flow from an initial sign up interface 502 to display of meal plan options at 504 (e.g., 4 plans, 5 plans, 6 plans, etc.). According to one embodiment, users can select specific meal options at 506 once they have subscribed to a meal plan.

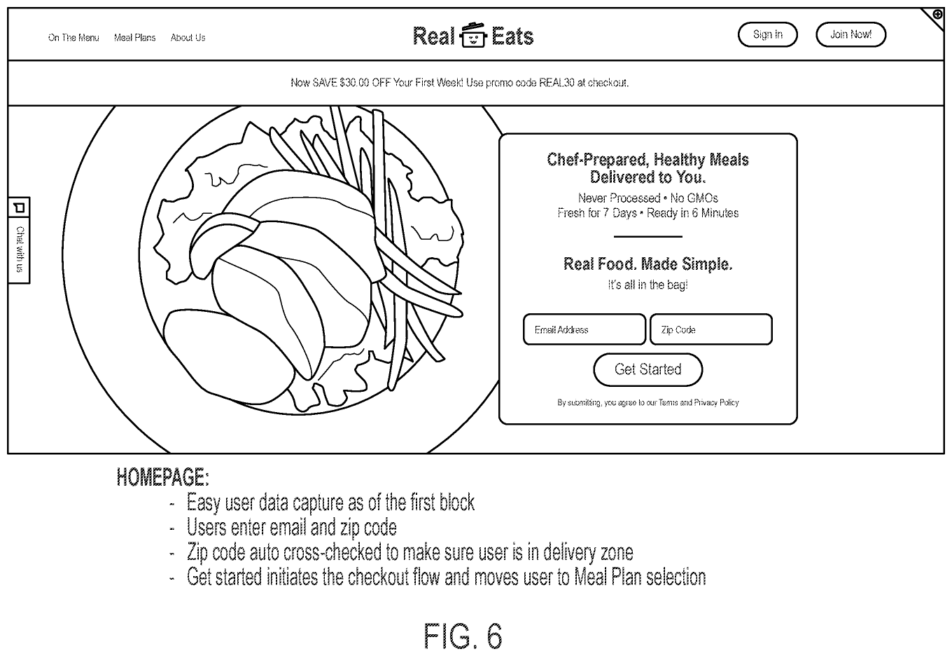

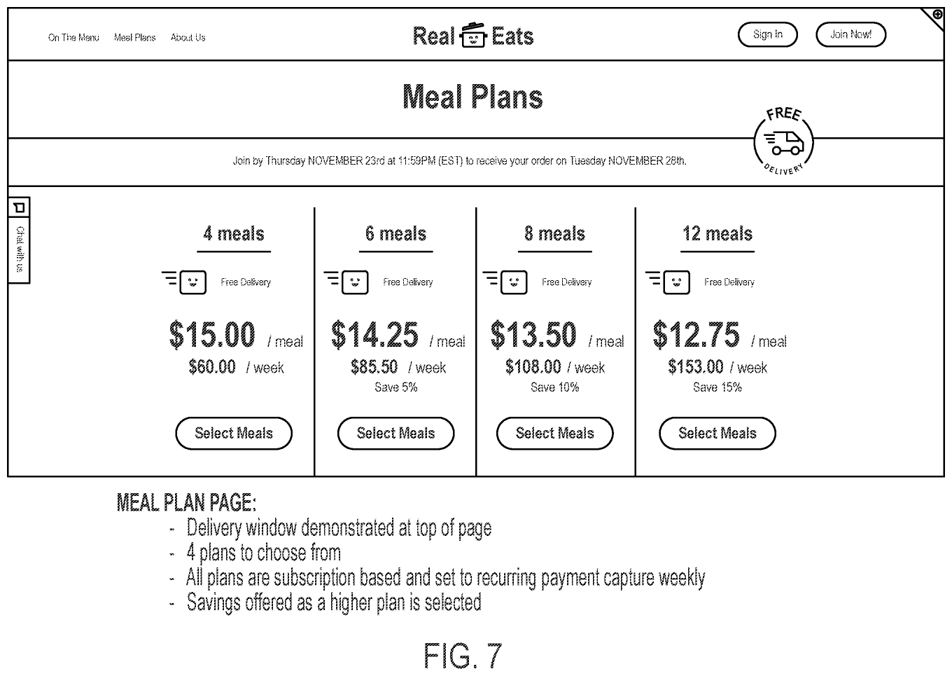

FIGS. 6 and 7 show example screen capture of example pages. FIG. 6 shows an example home page, and FIG. 7 example options for meal plans.

In another embodiment, a second component of the user interface is configured for static display (e.g., display that are changing less frequently than the first component). For example, the “static” display portion can be configured to change every few months based on sales trends of top dishes. According to one example, the second component is configured to display a title of “The Best Sellers,” and provide a menu of selections by the end users. The Best Sellers meals are developed by the in-house chef teams as described is greater above.

In some implementations, both UI components are configured to provide selectable menus that can be displayed on the website (or through an installed app) to anyone. Further, the same menus are configured for access in a customized Meal Selection display/module. The customized meal selection display can be triggered when the system is executing the checkout flow. Further the customer meal selection display/module can be accessed via a Meal Planner display generated by the system, for example, when the user logs in to their account.

In some embodiments, customers may select personalized, customized meals. Customers may choose individual meal components from a mix and match menu. Protein components, for example, may be decoupled from side dish components, allowing consumers to select and create individualized meal selections from the menu choices according to their preferences. Each meal component is individually packaged in modular format allowing the customers to receive entire meals of their choice of desired components, increasing customer satisfaction and retention. For example, a customer may select a protein component from a list including, for example, beef, chicken, or fish selections. The customer may also choose individual side components from a list including, for example, pasta, rice, potatoes and a variety of vegetable selections. The customer orders the desired meal selections from the list of individual components, and each of those individual components will be sealed, by, for example, vacuum sealing, separately from the others, and then packaged for shipment to the customer.

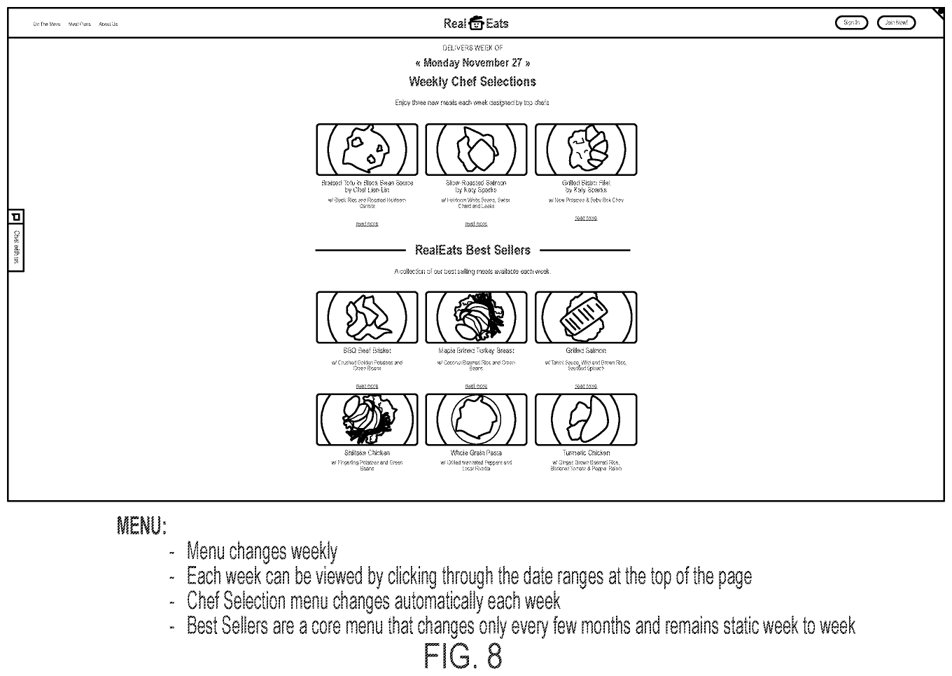

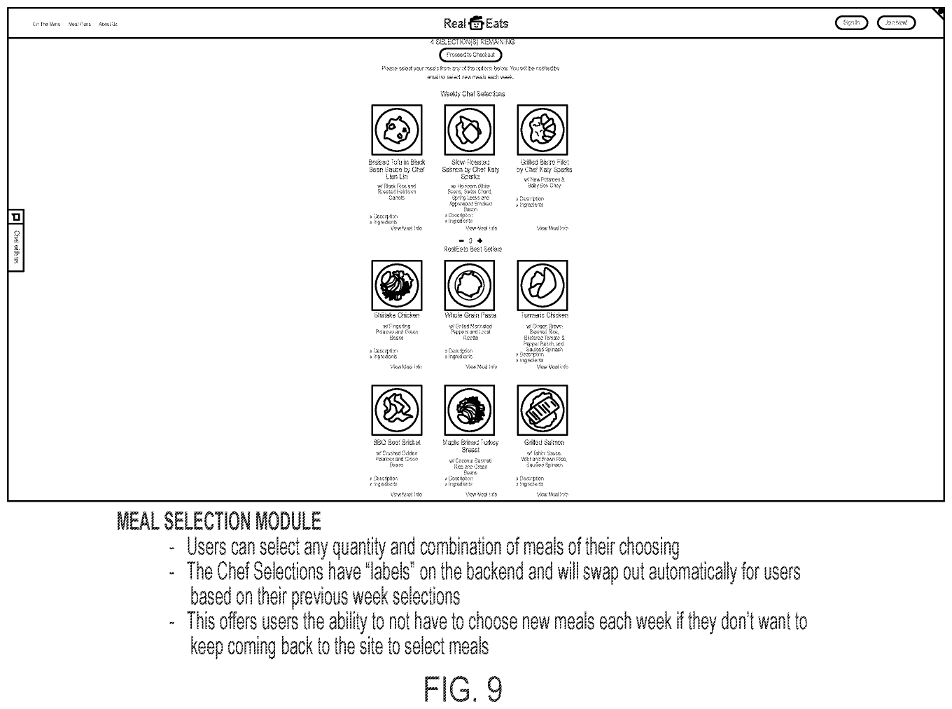

FIG. 8 is an example screen capture and description of some functions provided through the interface. For example, users can view “Chef Selections” or best sellers to make menu selections. FIG. 9 is an example screen capture and description of some functions provided through the interface. For example, users can view and select any quantity and combination of meal components, or meals in the interface.

According to one embodiment, the system is configured to enable users to choose their meals up to 1-2 months in advance of a delivery. The system is configured to accept “skip” instructions for any time period. The skip instructions can be associated with, for example, plans for a user to be away on business or vacation. The user interface can provide a calendar for selection of meals and/or skip dates. In some examples, the UI is configured to prevent users from accessing or selecting dates in the UI beyond the 1-2 month advanced window for ordering purposes.

In some embodiments, the system is configured to enable a user to override the display/selection lockout, but with notifications that such selections may not be honored (e.g., menu changes may occur, become unavailable, etc.). In some examples, the system displays an override notification that the user must accept/acknowledge/agree to before scheduling past the 1-2 month window. In further examples, the system is configured to monitor such orders and notify the user if an order cannot be fulfilled. In one example, the system may automatically substitute a similar meal or order. In another example, the system may analyze prior orders to develop a substitute. If the user does not respond to the notifications on the changes, the system selected option can be executed.

According to another embodiment, the system provided notifications to the users that they have a limited window to select or alter meals. The system is configured to establish an order period or order window configured to enable sufficient preparation and shipment to respective users. In some embodiments, the system can dynamically adjust the order window based on user requests. For example, if large numbers of requests are accepted on the system, the system may altered the displayed order window (e.g., requiring additional time to fulfill) to accommodate the large volume. For example, the user interface is configured to dynamically change displays of options as incoming requests are identified and process. In some examples, the system is configured to automatically adjust to order volume and dynamically adjust an order window.

In some examples, users have up until a pre-specified date and time (e.g., Wednesday 11:59 pm EST) to select meals or skip the next order. The system is configured to automatically generate and communicate an email, to notify users three days in advance to pick meals or skip prior to the Wednesday cut-off mentioned above. In some embodiments, upon login, the system determines if the current user has made a selection for the current time period and displays a warning screen and associated countdown (e.g., 3 days until selection window closes—and dynamic windows associated with heavily ordered items can also be displayed with, or separately from the warning screen (e.g., 2 days until selection window for fresh salmon meal closes)).

According to one embodiment, orders made on the system are configured to recur (e.g. on a weekly basis) and the system allocates resources (e.g., food items, chef preparation time, cooling systems/resources) automatically the day after the ordering deadline. In one example, the system automatically allocates all resources and the user is also automatically charged one the resources are allocated. Deliveries for all meals are scheduled for delivery on the following week by the system. In one example, the system includes a shipping API tied into commercial shipping providers (e.g., UPS) that can be automatically called by the system to trigger shipment and delivery of orders. In other example, the system coordinates shipping from a carrier location.

The system can be configured to carry over selections made in the user interface from the Best Sellers menu. The system can also be configures to swap out selections made from the Chef menu in favor of the new the new rotating meals (e.g., weekly). Once orders are auto-generated (at the order window deadline), users cannot swap out meals and the order is locked in on the system.

Example User Interface Screens

FIG. 6-9 illustrates various screen captures of user interfaces displayed by the system. The user interfaces help, for example, facilitate, manage, and execute forecasting operations, management control to ensure resources, timing, and consistency of product, among other options and functions discussed herein.

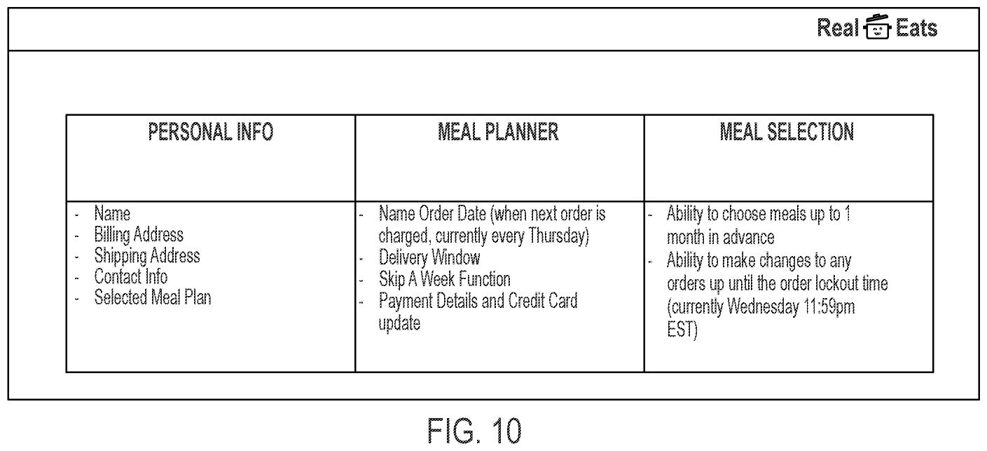

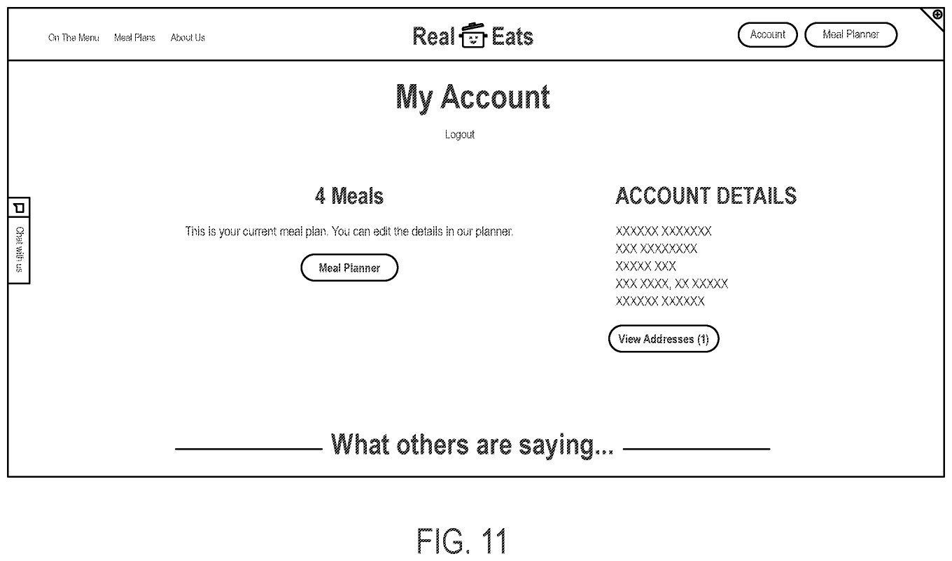

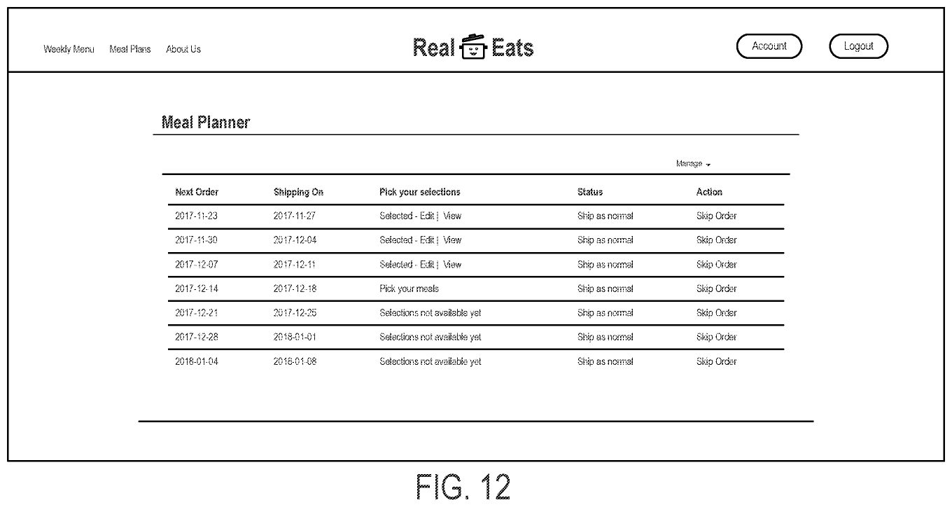

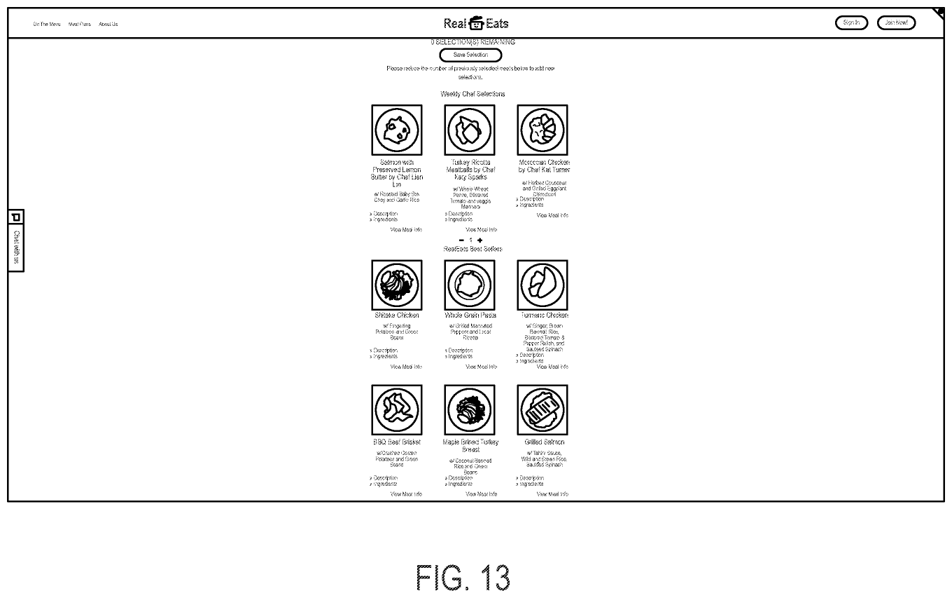

FIG. 10 illustrates information elements used by the user interface in establishing user information and/or selections. FIG. 11 is an example screen capture. In FIG. 11, the system provides one button access to meal planning functions, with plan selection display showing in the main body of the screen. Other user information is provided to allow any needed updates. FIG. 11 is an example screen capture. FIG. 12 is an example screen capture of a meal planner page with details. Provided in the display is a next order date, with charge data, details for the shipping on date, pick your meal selection item, or combination of component items, to transition to a screen for meal selection, status, and action options (e.g., to allow a user to skip a week at time (e.g., away on business). FIG. 13 is an example screen capture of a meal planner details page. The user can select or eliminate selections in the user interface for any given week before an order lockout date.

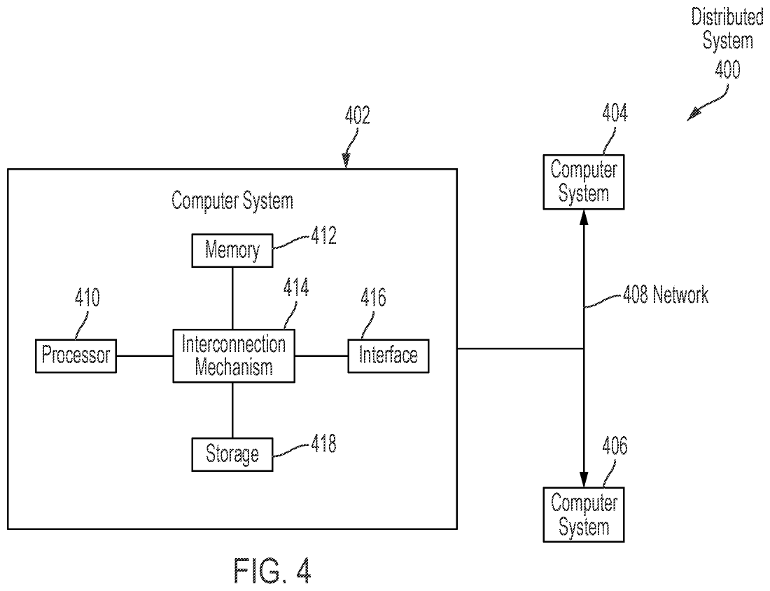

The various functions, processes, APIs and/or pseudo code described herein can be configured to be execute on the systems shown by way of example in FIG. 4. The systems and/or system components shown can be specially configured to execute the processes and/or functions described. Various aspects and functions described herein, in accord with aspects of the present invention, may be implemented as specially configured hardware, software, or a combination of hardware and software on one or more specially configured computer systems. Additionally, aspects in accord with the present invention may be located on a single specially configured computer system or may be distributed among one or more specially configured computer systems connected to one or more communication networks.

Further embodiments, can be implemented in an direct user subscriber approach, while other embodiments can include retail to customer interactions, and the system can supply both types of clients, and prediction usage requirements based on analysis of finished product needed by either or both types of supply.

For example, various aspects, components, and functions may be distributed among one or more special purpose computer systems configured to provide a service to one or more client computers, mobile device, or to perform an overall task as part of a distributed system. Additionally, aspects may be performed on a client-server or multi-tier system that includes components or engines distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 4, there is illustrated a block diagram of a distributed special purpose computer system 400, in which various aspects and functions are practiced (e.g., including a forecast component configured to anticipate demand based on projection models of orders, customer selections, etc., a modelling component (e.g., configured to map projected demand for various orders to specific preparation lists of ingredients, amounts, timings, and/or needed resources), a monitoring component (e.g., configured to dynamically and/or in real time update projections as actual order information is received, triggering updates with or through the modelling component, ensuring compliance with delivery guarantees, ordering window timing, etc.), a packaging component (e.g., configured to manage transition from prepared food to packaged meals for shipping (e.g., portioning, chilling, and vacuum sealing, among other options), a delivery component (e.g., configured to manage shipments, including assigning sufficient cooling resources per package (e.g., including dynamically configuring coolant to expected shipping conditions, among other options)), etc.

As shown, the distributed computer system 400 includes one more special purpose computer systems that exchange information. More specifically, the distributed computer system 400 includes computer systems 402, 404 and 406. As shown, the computer systems 402, 404 and 406 are interconnected by, and may exchange data through, a communication network 408. For example, a segment of a distributed database can be implemented on 402, which can communicate with other systems (e.g., 404 and 406), which host other or remaining portions of the system, message data, and/or copies of the linked message data.

In some embodiments, the network 408 may include any communication network through which computer systems may exchange data. To exchange data using the network 408, the computer systems 402, 404 and 406 and the network 408 may use various methods, protocols and standards, including, among others, TCP/IP, or other communication standard, and may include secure communication protocols VPN, IPsec, etc. To ensure data transfer is secure, the computer systems 402, 404 and 406 may transmit data via the network 408 using a variety of security measures including, for example, TLS, SSL or VPN or other standard. While the distributed computer system 400 illustrates three networked computer systems, the distributed computer system 400 is not so limited and may include any number of computer systems and computing devices, networked using any medium and communication protocol.

As illustrated in FIG. 4, the special purpose computer system 402 includes a processor 410, a memory 412, a bus 414, an interface 416 and data storage 418 and further includes any one or more of the component discussed above to implement at least some of the aspects, functions and processes disclosed herein, as either a stand-alone system or part of a distributed system. In some embodiments, the processor 410 performs a series of instructions that result in manipulated data. In various embodiments, each of the functions described herein are reflected in executable code that may be run by the processor. The processor 410 may be any type of processor, multiprocessor or controller. The processor 410 is connected to other system components, including one or more memory devices 412, by the bus 414.

The memory 412 stores programs and data during operation of the computer system 402. Thus, the memory 412 may be a relatively high performance, volatile, random access memory such as a dynamic random access memory (DRAM) or static memory (SRAM) or other standard. However, the memory 412 may include any device for storing data, such as a disk drive, hard drive, or other non-volatile storage device. Various examples may organize the memory 412 into particularized and, in some cases, unique structures to perform the functions disclosed herein. These data structures may be sized and organized to store values for particular to specific database architectures and specific data types, and in particular, may include standardize formats for organizing and managing data storage.

Components of the computer system 402 are coupled by an interconnection element such as the bus 414. The bus 414 may include one or more physical busses, for example, busses between components that are integrated within the same machine, but may include any communication coupling between system elements including specialized or standard computing bus technologies. The bus 414 enables communications, such as data and instructions, to be exchanged between system components of the computer system 402.

The computer system 402 also includes one or more interface devices 416 such as input devices, output devices and combination input/output devices. Interface devices may receive input or provide output. More particularly, output devices may render information for external presentation. Input devices may accept information from external sources. Examples of interface devices include keyboards, mouse devices, microphones, touch screens, printing devices, display screens, speakers, network interface cards, etc. Interface devices allow the computer system 402 to exchange information and to communicate with external entities, such as users, vendors, and other systems.

The data storage 418 includes a computer readable and writeable nonvolatile, or non-transitory, data storage medium in which instructions are stored that define a program or other object that is executed by the processor 410. The data storage 418 also may include information that is recorded, on or in, the medium, and that is processed by the processor 410 during execution of the program. More specifically, the information may be stored in one or more data structures specifically configured to conserve storage space or increase data exchange performance.

The instructions stored in the data storage may be persistently stored as encoded signals, and the instructions may cause the processor 410 to perform any of the functions described herein. The medium may be, for example, optical disk, magnetic disk or flash memory, among other options. In operation, the processor 410 or some other controller causes data to be read from the nonvolatile recording medium into another memory, such as the memory 412, that allows for faster access to the information by the processor 410 than does the storage medium included in the data storage 418. The memory may be located in the data storage 418 or in the memory 412, however, the processor 410 manipulates the data within the memory, and then copies the data to the storage medium associated with the data storage 418 after processing is completed. A variety of components may manage data movement between the storage medium and other memory elements and examples are not limited to particular data management components. Further, examples are not limited to a particular memory system or data storage system.

Although the computer system 402 is shown by way of example as one type of computer system upon which various aspects and functions may be practiced, aspects and functions are not limited to being implemented on the computer system 402 as shown in FIG. 4. Various aspects and functions may be practiced on one or more specially configured computers having different architectures or components than that shown in FIG. 4 which can be modified to include the specially purpose components and/or functions discussed. For instance, the computer system 402 may include specially programmed, special-purpose hardware, such as an application-specific integrated circuit (ASIC) tailored to perform any one or more operations disclosed herein (e.g., validating received operations, routing write operations, replicating operations, among other examples). While another example may perform the same function(s) using a grid of several computing devices running MAC OS System X with Motorola PowerPC processors and several specialized computing devices running proprietary hardware and operating systems.

The computer system 402 may be a computer system including an operating system that manages at least a portion of the hardware elements included in the computer system 402. Additionally, various aspects and functions may be implemented in a non-programmed environment, for example, documents created in HTML, XML or other format that, when viewed in a window of a browser program, can render aspects of a graphical-user interface or perform other functions.

According to one embodiment, a communication system can include one or more APIs for integrating virtual cloud services (“VCS”) or applications, as well as APIs for maintaining functionality and real time communication channels in cloud provided resources.

Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g., specialized hardware, executable code, data structures or data objects, that are configured to perform the functions described herein.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

Use of ordinal terms such as “first,” “second,” “third,” “a,” “b,” “c,” etc., in the claims to modify or otherwise identify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A production system and controllers for product generation, the system comprising:
at least one processor operatively connected to a memory;
a preprocessing controller, executed by the at least one processor, configured to control pre-production execution;
a first set of sensors configured to monitor a first production stage;
an automation controller, executed by the at least one processor, configured to receive monitored information from the first set of sensors, and control transition from the first production stage to at least a second stage of the execution responsive to exceeding a threshold measured by the first set of sensor systems;
a second set of sensor systems configured to monitor a second production stage;
wherein the automation component is configured to control a transition from the second production stage to a third production stage;
a temperature controller, executed by the at least one processor, configured to control generation of cooling material; and
trigger execution of delivery to respective users with the cooling material.

2. A production system and controllers for managing testing, preparation and delivery of product, the system comprising:
at least one processor operatively connected to a memory;
a preprocessing controller, executed by the at least one processor, configured to manage pre-production execution;
an automation controller, executed by the at least one processor, configured to control at least a first set of sensor systems for monitoring production, and control transition from a first production stage to at least a second stage of the production responsive to exceeding a threshold measured by the first set of sensor systems; and
a transit controller, executed by the at least one processor, configured to trigger execution of delivery to respective users with the cooling material.

3. The system of claim 2, further comprising a cooling controller configured to rapidly reduce temperature of target.

4. The system of claim 2, wherein the at the first set of sensors systems includes temperature detectors disposed in a cooling unit, where in the automation controller is configured to control a transition from a cooling stage for the product to a packing stage.

5. The system of claim 4, wherein the system further comprising a packing component configured to vacuum seal the product, responsive to determining the product has reached a threshold temperature.

6. The system of claim 5 wherein the product comprises a meal including a protein component and at least one side component.

7. The system of claim 5 wherein the product comprises a meal including a protein component and at least two side components.

8. The system of claim 6 wherein the protein component and the at least one side component are individually vacuum sealed.

9. The system of claim 2, wherein the transit controller is configured to generate cooling material for packing with the product.

10. The system of claim 9, wherein the transit controller is configured to determine a needed volume of cooling material based on a temperature analysis.
